(19) United States
(12) Patent Application Publication
(10) Pub. No.: US 2006/0092921 A1
(43) Pub. Date: May 4, 2006

(54) Configuration for using open programming languages to dynamically configure packet processing rules

(76) Inventors: Rajesh Narayanan, Sunnyvale, CA (US); Mark Mah, Saratoga, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/248,031

(22) Filed: Oct. 11, 2005

Related U.S. Application Data
(60) Provisional application No. 60/618,375, filed on Oct. 12, 2004.

(51) Int. Cl. H04J 1/16; H04L 12/66; H04L 12/56

(52) U.S. Cl. 370/352; 370/235; 370/412

(57) ABSTRACT

A system dynamically configures a packet or data processor to support new data types or processing rules. Initially, a first data in an open programming language is received from a first source. This first data specifies the format in which a second data is structured and specifies a set of rules that provides what operations need to be performed to process the second data. The first data is then stored into a temporary storage location. A second data is received from a second source and the first data is used to determine the structure and contents of the second data. After determining the structure and contents of the second data, the set of rules specified by the first data is applied to the second data and produces an output.

### CROSS REFERENCE TO RELATED APPLICATIONS

This application claims a benefit of, and priority under 35 USC § 119(e) to, U.S. Provisional Patent Application No. 60/618,375, filed Oct. 12, 2004, and titled “A Method to Use Application Programming Interfaces to Configure Packet Processing Rules on Computing and Networking Systems”, the contents of which are herein incorporated by reference.

### BACKGROUND OF THE INVENTION

1. Field of the Invention

The present invention generally relates to the field of network or packet processing systems, and more specifically, to software configurable real-time network or packet processing systems.

2. Description of the Related Art

Most networked computing systems, such as routers, switches and remote-access-servers, do some type of packet or data processing. This packet or data processing involves modifying a packet based on certain conditions or rules that are recognized by the networked computing system. Existing packet or data processing systems learn the rules to be applied to packets or data through implicit configuration or network protocols.

In an implicit configuration processor, a configuration message triggers an algorithm that is pre-configured into the packet or data processor. In a network protocol processor, a configuration message instructs the packet or data processor to act on known headers or parts of the packet or data frame.

Neither implicit configuration nor network protocol packet or data processors receive as input the actual algorithm describing how to process the packet or data frame. Both types of packet or data processors only receive a configuration message specifying which underlying actions need to be performed on the packet or data frame. Thus, the packet or data processor is limited to only performing actions that have been pre-configured into the processor.

Because the packet or data processor determines which rules to apply by translating a protocol action or configuration event into a proprietary internal action, rules for modifying packets or data cannot be dynamically added or modified. Similarly, existing packet or data processors cannot be dynamically configured to support proprietary protocols; rather, the processor must be initially compiled with an algorithm that supports the proprietary protocol. Thus, applying new rules or supporting new packet or data formats requires re-configuring and rebooting the data processor.

Thus, from the above, there is a need for a system and process to dynamically configure packet or data processors to support new algorithms, packet formats or data formats, including a generic packet or data processor that receives a set of rules defined in a generic language from an external entity then applies the received rules to received packets.

### SUMMARY OF THE INVENTION

One embodiment of a disclosed system (and method) includes a rules engine which receives a first data from one source. This first data is specified in an open programming language and describes a format in which a second data is structured. The first data also describes an algorithm specifying what operations to perform on the second data.

The rules engine stores the first data into temporary storage. The rules engine also receives a second data from a second source then uses the first data to determine the structure and contents of the second data. After determining the structure and contents of the second data, the rules engine uses the algorithm specified by the first data to perform operations on the second data and produce an output.

In one embodiment, the system allows the source supplying the first data to specify how the rules engine operates on information and what data formats the rules engine can process. Hence, the rules engine can be dynamically configured, by the first data, to process different types of data or to apply different rules.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

The disclosed embodiments have other advantages and features which will be more readily apparent from the following detailed description and the appended claims, when taken in conjunction with the accompanying drawings, in which:

FIG. (FIG.) 1 illustrates one embodiment of a block diagram of a packet or data processor.

FIG. 2 illustrates one embodiment of a block diagram of a system for dynamically modifying rules used for processing packets.

FIG. 3 illustrates one embodiment of different components within packets transmitted across a communication network.

FIG. 4 illustrates one embodiment of a communication network using a packet processor.

FIG. 5 illustrates one embodiment of a rule set to be used by a packet or data processor.

FIG. 6 illustrates one embodiment of an application of a rule set to a packet by a packet processor.

FIG. 7 illustrates one embodiment of a flow diagram corresponding to application of a rule set to a packet.

FIG. 8 illustrates one embodiment of using an open programming interface to specify rules to be applied to packets.

FIG. 9 illustrates an example packet or data frame and how the packet is modified by application of a rule.

FIG. 10 illustrates one embodiment of a block diagram of a system for dynamically configuring a packet processor.

### DETAILED DESCRIPTION OF THE PREFERRED EMBODIMENTS

The Figures (FIGS.) and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments, examples of which are illustrated in the accompanying figures. It is noted that wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles described herein.

Generally, the disclosed embodiments describe a system and method for configuring dynamically a packet or data processor by using a generic packet or data processing engine that receives, from an external entity, rules defined in an open programming language, for example, extensible markup language (XML), hypertext markup language (HTML), extensible hypertext markup language (XHTML) or JAVA® (Sun Microsystems, Inc. Palo Alto, Calif.). This configuration allows the dynamically configurable packet or data processor to add or modify packet processing rules without modifying the underlying code base that specifying the basic configuration and operation of the packet or data processor. In this configuration, the packet processing rules can be stored in volatile memory separate from the non-volatile memory storing the configuration and operation information of the dynamically configurable packet processor.

System Overview

Referring now to FIG. 1, it illustrates an embodiment of a dynamically configurable packet processor 105 constructed in accordance with the present invention. The dynamically configurable packet processor 105 contains two components, a service entity 110 and a rules based packet processing engine 115. The service entity 1 10 is a module or process that receives rules specifying packet processing rules from an external entity 120. The service entity can be considered to be a process or module that resides in a location distinct from the rules based packet processing engine 115 but interacts with the rules based packet processing engine 115.

The service entity 110 couples with one or more external entities 120. The coupling can be direct or indirect, wired or wireless, for example, through a communications medium such as an intranet or the Internet. Likewise, the rules based packet processing engine 115 is connected to one or more external computing entities 125, 130 either directly or indirectly, wired or wireless, for example, through a communications medium such as an intranet or the Internet.

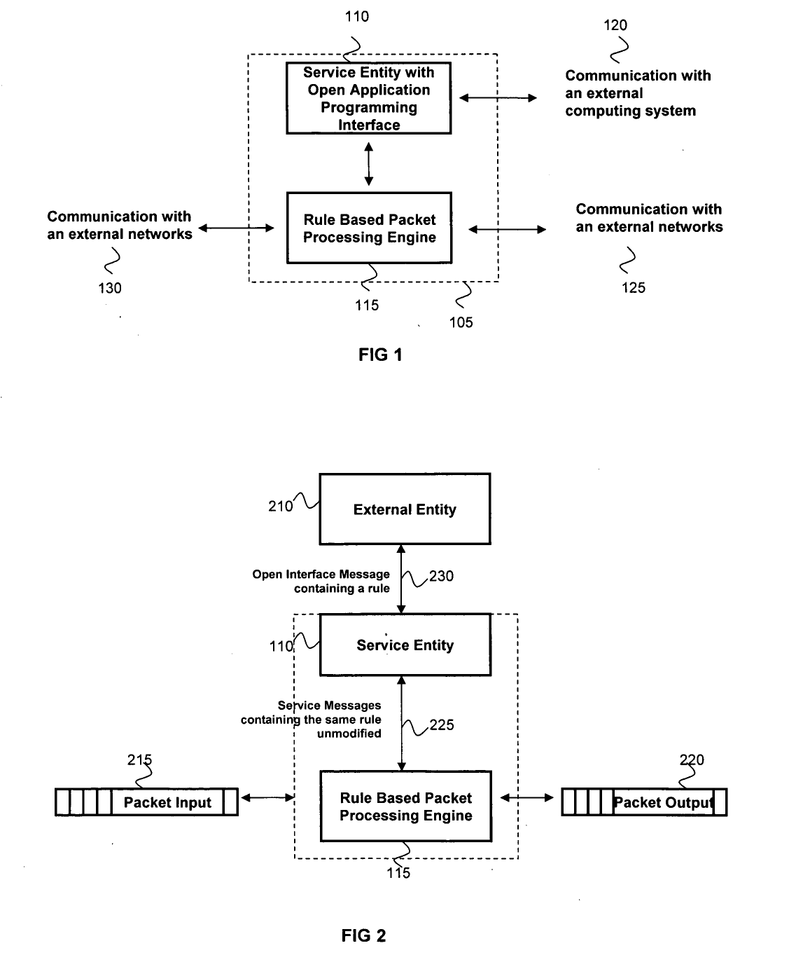

FIG. 2 illustrates one embodiment of an external entity 210, which could be any computing system, connected to the service entity 110. The service entity 110 is configured to allow the external entity 210 to specify the rules describing how to process data 230. Without modifying the rules describing how to process data 230, the service entity 110 communicates the rules to the rules based packet processing engine 115. The service entity 110 could be in any form, for example it could be a process within the rules based packet processing engine 115 or it could be an entity physically distinct from the rules based packet processing engine 115. The service entity 110 communicates with the external entity 210 through a message in an open programming language containing a rule describing how to process the data 230 received by the rules based packet processing engine 210.

The rules based packet processing engine 115 receives data 215, e.g., input data packet, which could be in the form of packets or data-frames, from an external entity, which may or may not be the same external entity 210 that communicates with the service entity 210. The rules based packet processing engine 115 then processes the received data 215 according to the rule describing how to process data 230 supplied by the external entity 210. Depending on the rule describing how to process data 230, the rules based packet processing engine 115 may transmit the processed data 220, e.g., output data packet, to an entity which may or may not be the same as the external entity 210 which communicated with the service entity 110.

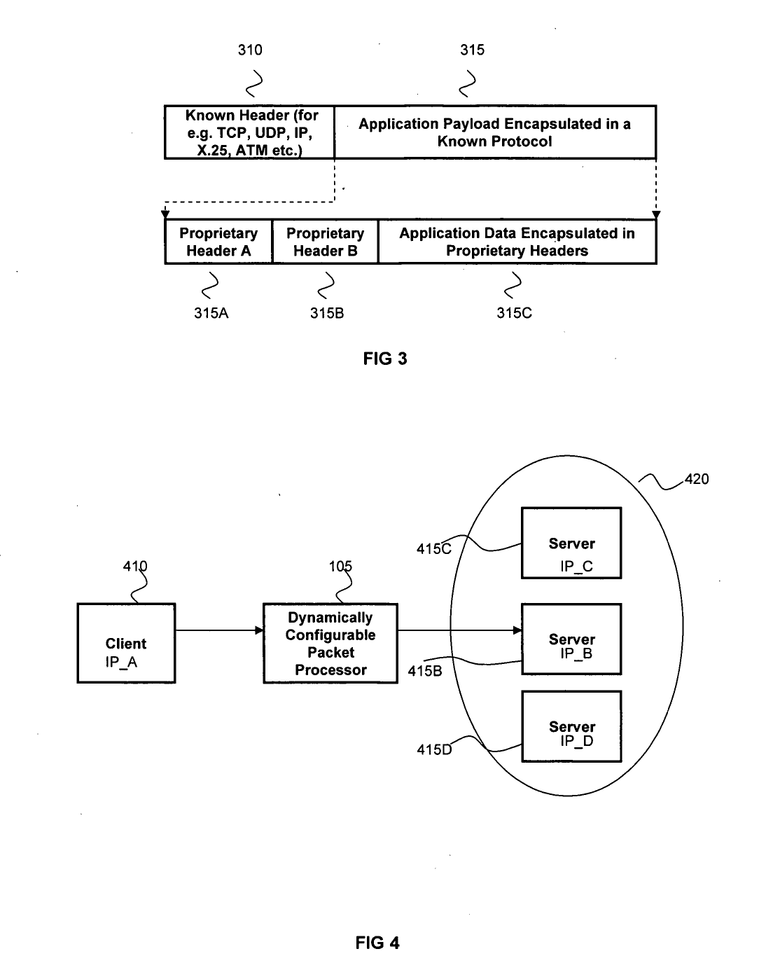

FIG. 3 illustrates one example of a packet which could be received data 215 to be processed by a dynamically configurable packet processor 105. The packet contains a well known header 310 which could be defined in a well-known and standard protocol such as Internet protocol (IP), transmission control protocol (TCP), user datagram protocol (UDP), asynchronous transfer mode (ATM) or X.25. The application payload 315 of the packet may contain one or more proprietary headers 315A 315B as well as application data 315C.

FIG. 4 illustrates one embodiment of an example network using a dynamically configurable packet processor 105. In the example network, a client 410, which could be any computing system that transmits or receives data, needs to communicate with one or more servers, e.g., 415C, 415B, 415D. The client 410 transmits data to the dynamically configurable packet processor 105, which determines which server 415C, 415B, 415D should receive the data. The rules based packet processing engine applies the rules received from the service entity 110 to determine which server 415C, 415B, 415D should receive the data transmitted by the client 410. The dynamically configurable packet processor 105 could be implemented many ways. For example, it may be structured as a software process and/or a firmware application. The software and/or firmware can be structured to operate on a general purpose microprocessor or controller, a field programmable gate array (FPGA) or an application specific integrated circuit (ASIC) or a combination thereof.

Example Application of Dynamic Rule Configuration

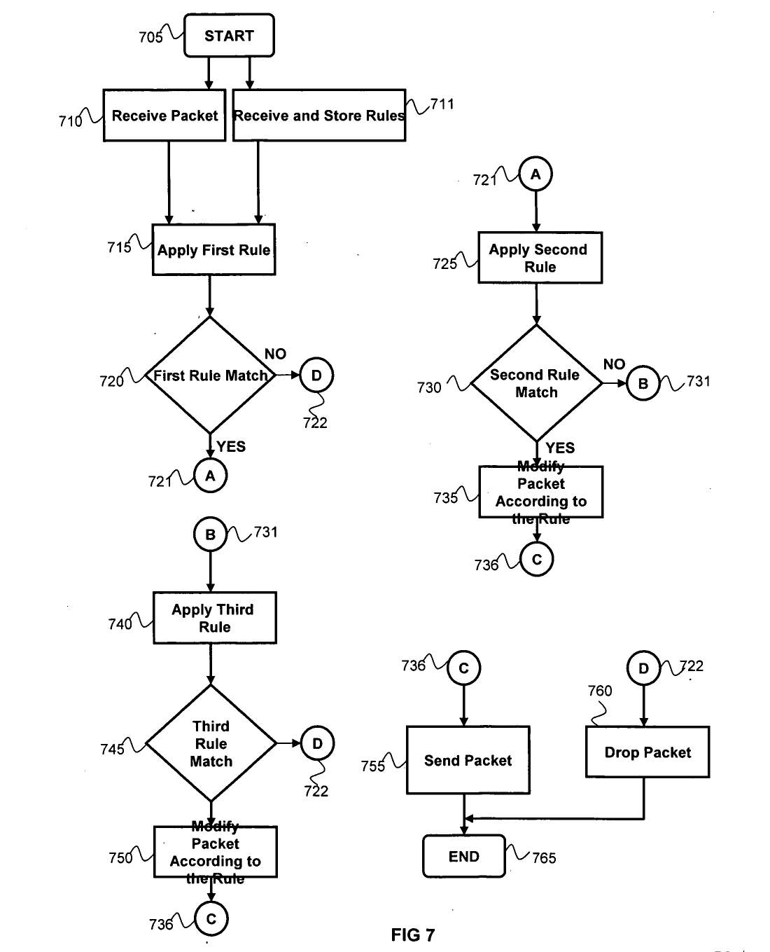

FIGS. 5 through 7 provide one example of using a dynamically configurable packet processor 105 to process a packet 600 containing proprietary application data 630. FIG. 5 describes one example of a rule set to be applied by the dynamically configurable packet processor 105. A set of four rules are described and labeled as Rule 1 510, Rule 2 515, Rule 3 520, Rule 4 525. In this example, the dynamically configurable packet processor 105 is already operating and is not preloaded with Rule 1 510, Rule 2 515, Rule 3 530 or Rule 4 525. As illustrated in FIG. 7, the dynamically configurable packet processor receives the set of rules while it is operating and stores 711 those rules into temporary storage. The dynamically configurable packet processor 105 may receive the rules before receiving the packet 600, at the same time as receiving the packet 600 or after receiving the packet 600.

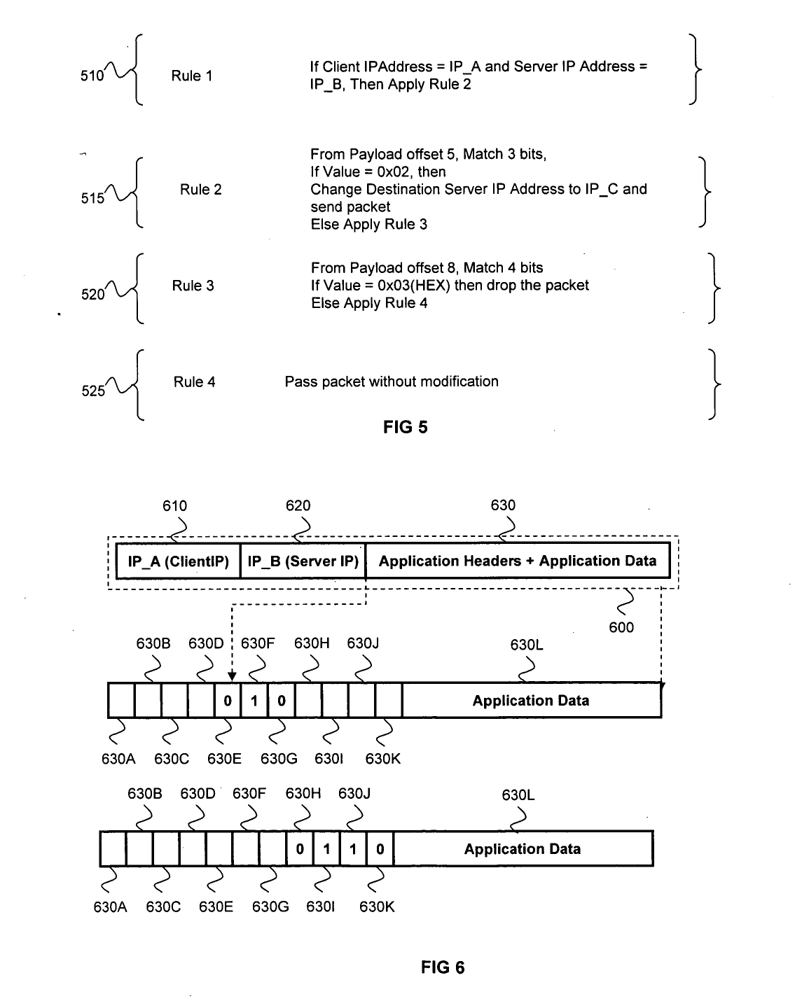

Turning to FIG. 6, it illustrates how the dynamically configurable packet processor 115 applies Rule 1 510, Rule 2 515, Rule 3 520 and Rule 4 525 to a packet 600 with proprietary application data 630. The packet 600 contains an Internet protocol (IP) header specifying the client IP address 610 and an IP header specifying the server IP address 620. Also, the packet 600 contains an application payload 630 with an application header 630A-K and application data 630L. In this example, the application header 630 A-K consists of an 11-digit binary number. The use of binary digits is only for the purpose of explaining this example and does not prevent use of other data representations such as ASCII or hexadecimal digits.

In this embodiment, once received by the dynamically configurable packet processor 105, the rules are applied to packets received after the rules. In this example, the rules apply to the IP header specifying the client IP address 610, which is based on a well-known and standard protocol, and the proprietary application payload header 630A-K. Rule 1 510 instructs the dynamically configurable packet processor 115 to compare the IP header specifying the client IP address 610 with a known value. If the IP header specifying the client IP address 610 and known value match, which occurs in this example, Rule 2 515 is applied.

Rule 2 515 specifies a comparison involving the proprietary payload header 630A-K of the packet 600. Because the packet 600 contains proprietary application data 630, Rule 2 515 uses packet offsets, rather than specific terminology, to specify the relevant packet section. By receiving the packet processing rules in an open programming language, for example, XML, HTML, XHTML, JAVA®, the dynamically configurable packet processor 115 is able to process the proprietary packet without knowing in advance the contents of the proprietary payload.

Receiving the rules for packet processing on-the-fly (e.g., real-time) enables the dynamically configurable packet processor 105 to support packet types unknown when the dynamically configurable packet processor 105 was first designed. This configuration allows the dynamically configurable packet processor 105 to support protocols developed subsequent to the packet processor design. Using the offset value specified in Rule 2 515, the dynamically configurable packet processor 105 is able to perform the pattern match needed to process the packet. Similarly, Rule 3 520 acts on the proprietary header 630A-K of the packet 600 by using a specified offset to compare the packet contents to a specified value.

Referring back to FIG. 7, it illustrates a flow diagram of how the dynamically configurable packet processor 105 applies Rule 1 510, Rule 2 515, Rule 3 520 and Rule 4 525 to the received packet 600. The dynamically configurable packet processor 105 starts 705 with receiving 710 a packet. It also receives and stores 711 the rules. Receipt and storage 711 of the rules can occur before, during or after receipt 710 of the packet. After receiving the packet and rules, the process applies 715 the first rule and determines 720 if the rule has been met. If the first rule is not met 722, the packet is dropped 760 and processing of that packet is stopped 765.

If the first rule is met 721, the processor applies 725 the second rule and determines 730 if the second rule has been met. If the second rule is met, the dynamically configurable packet processor 105 modifies 735 the packet according to the second rule then sends 755 the packet before stopping 765 processing of the packet. If the second rule is not met 731, the dynamically configurable packet processor 105 applies 740 the third rule and determines 745 if the third rule has been met. If the third rule is met, the processor modifies 750 the packet according to the third rule then sends 755 the packet before stopping 765 processing of the packet. If the third rule is not met 722, the packet is dropped 760 and processing of that packet is stopped 765.

Example Specification of Packet Processing Rules

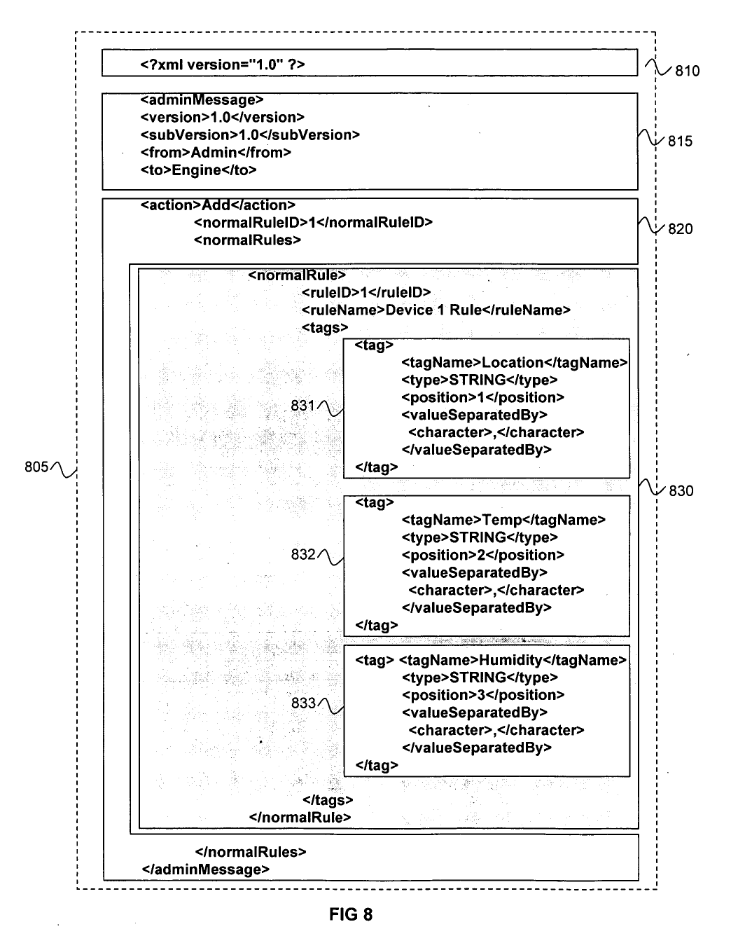

FIG. 8 illustrates a sample XML interface 805 with a packet processing rule 830 embedded in the interface. It is noted that the description that follows for the interface is an example and does not limit other embodiments of the invention. In this example, the packet processing rule converts proprietary data formats into a standardized XML format that can be understood by an enterprise application. The rule based processing engine 115 which receives the XML interface 805 understands the packet processing rule 830 defined in the XML interface 805.

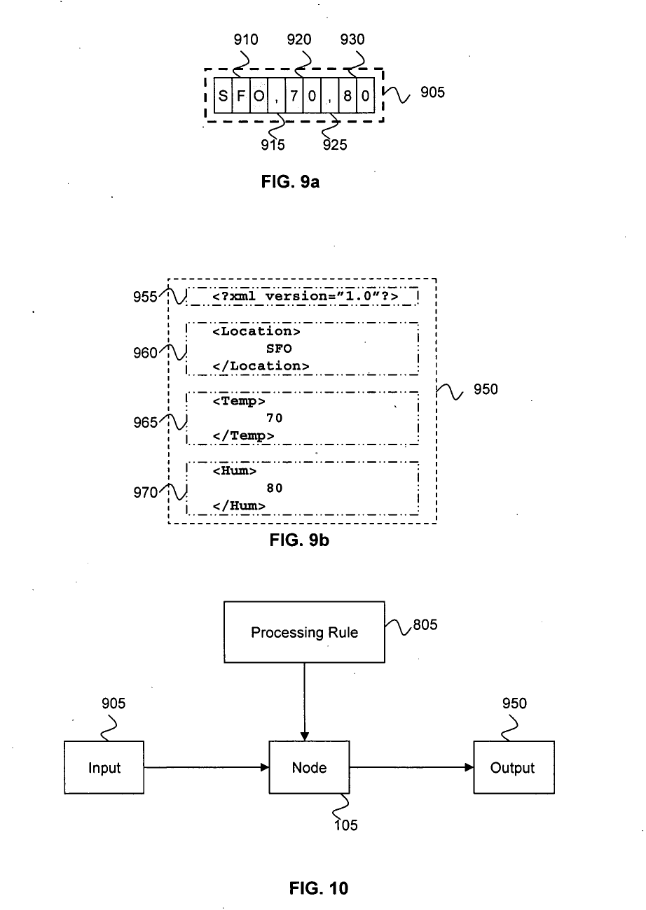

FIG. 9A illustrates one embodiment of a non-standard data packet 905 that is to be received by the dynamically configurable packet processor 105. In this example, a non-standard data packet 905 contains a stream of comma-delimited ASCII characters. Here, the non-standard data packet 905 contains ASCII characters that represent location information 910, current temperature 920 and current humidity 930.

FIG. 9B illustrates the resulting output data 950 when a dynamically configurable packet processor 105 applies the XML-defined packet processing rule 830 to the received non-standard data packet 905. The output data 950 is in the form of an XML document containing different fields corresponding to the different data fields in the non-standard data packet 905.

As this example is XML based, the output data 950 is an XML document with a main tag 955 indicating the output data 950 is an XML document and indicates the appropriate version number of the XML document. The first field 960 stores the location information 910 from the non-standard data packet 905 as a string encapsulated in a tag called “<Location>.” Similarly, the second field 965 stores the temperature information 920 from the non-standard data packet 905 as a string encapsulated in a tag called “<Temp>.”Additionally, the third field 970 stores the humidity information from the non-standard data packet 905 as a string encapsulated in a tag called “<Hum>.”

FIG. 10 illustrates a block diagram of one embodiment of a system using the dynamically configurable packet processor 105. In this example, the dynamically configurable packet processor 105 receives rules specified in an open programming language 805, for example, XML, HTML, XHTML or JAVA®, from an external entity. The dynamically configurable packet processor 105 then applies these rules to process input data 905 and produce output data 950.

Relationship Between Example Rule Specification and Rule Engine Process

When the rules based packet processing engine 115 receives a packet processing rule 830, the rules based packet processing engine 115 first determines if the packet processing rule 830 is in an understandable format and determines if the received packet processing rule is valid 815. The validity of the packet processing rule 830 is specific to each implementation of a dynamically configurable packet processor 105 and depends on the format of the data received 215 by each implementation.

After determining the validity of the packet processing rule 830, the rule is stored in the memory of the rules based packet processing engine 115. Unlike conventional network processors, which must store processing rules in non-volatile memory, the rules based packet processing engine 115 is able to store the packet processing rule 830 in volatile memory. This allows the rules based packet processing engine 115 to store the processing rules and the underlying processor code base in separate physical locations. By separately storing the rules and code base, the rules based packet processing engine 115 is able to add or modify packet processing rules without altering the processor code base, allowing for rule addition or modification without rebooting or reconfiguring the rules based packet processing engine 115.

The rules based packet processing engine 115 processes received data 215 according to the information received by the rules based packet processing engine 115 from the service entity 110. For example, referring to FIG. 8, the XML interface 805 received by the rules based packet processing engine 115 contains a packet processing rule 830. The received packet processing rule 830 specifies what operations the rules based packet processing engine 115 performs on the received data 215. Referring again to FIG. 8, for example, because the received packet processing rule 830 contains the expression “<valueSeparatedBy><character>,</character></valueSeparatedBy>” which specifies to the rules based packet processing engine 115 that the input data 950 is comma-delimited.

The packet processing rule 830 received by the rules based packet processing engine 115 from the service entity contains the information necessary for processing the received data 215. In one embodiment, the information is structured as a configuration file. The rules based packet processing engine 115 generates a set of processing operations in response to the packet processing rule 830 it receives. Alternatively, the rules based packet processing engine 830 converts a received packet processing rule 830 into a set of processing operations.

By way of example, consider a process involving an open programming language such as XML. In this embodiment, the packet processing rule 830 is an XML document and the rules based packet processing engine 115 uses the tags 820 in the XML document to determine what information the received data 215 contains and what operations to perform on the received data 215. Referring again to FIG. 8, within the packet processing rule 830, the tag “<tagName>Location</tagName>” specifies to the rules based packet processing engine 115 that the received data 215 contains information specifying a location.

Specifying the packet processing rule 830. in an open programming language, for example, as HTML, XML, XHMTL or JAVA®, permits the rule itself to contain all the information necessary for implementation. This allows the rules based packet processing engine 115 to use the received packet processing rule 830, rather than information stored within the rules based packet processing engine 155, to determine how to process the received data 215. Using the received packet processing rule 830 rather than internal information makes the rules based packet processing engine transparent, enabling it to be dynamically configured by the received packet processing rule 830.

When the rules based packet processing engine 115 receives the input data 905, the rules based packet processing engine 115 applies the received packet processing rule 830. Each element of the packet processing rule 830 is applied sequentially to the input data 905. The packet processing rule 830 specifies the type of input data 905 received as well as instructions for how the rules based packet processing engine 115 should parse the input data 905 to find individual fields. Additionally, the packet processing rule 830 specifies how the rules based packet processing engine 115 should store the values it extracts from parsing the input data 905. Continuing to sequentially apply the elements of the packet processing rule 905 results in converting the input data 905 into output data 950.

Advantages of Dynamic Receipt of Packet Processing Rules

Advantages of the present invention include addition and modification of packet processing rules, processing of proprietary or non-standard protocols and support for new packet formats without altering the packet or data processor programming or rebooting the packet or data processor.

Sending the rules to the rules based packet processing engine 115 through a service entity 110 that does not modify the rules enables an external entity 210 to directly configure the rules based packet processing engine. The rules for packet processing are directly applied by the rules based packet processing engine 115 without first translating the rules into a format native to the rules passed packet processing engine 115. As the rules are provided by an entity other than the rules based packet processing engine 115, the rules can be defined so that the processing operations happen on any arbitrary set of bits within the packet, allowing for processing of non-standard protocol formats.

As the rules based packet processing engine 115 can process any type of packet depending on the packet structure definitions and algorithm received in the rules, the dynamically configurable packet processor 105 does not need to be rebooted to add new rules or packet types. New rules or packet types are added to a storage location in the rules based packet processing engine 115 and can be accessed by the rules based packet processing engine 115 without disrupting normal operation of the dynamically configurable packet processor 105.

Upon reading this disclosure, those of skill in the art will appreciate still additional alternative structural and functional designs for a system and a process for dynamically configuring packet or data processing rules through the disclosed principles herein. Thus, while particular embodiments and applications have been illustrated and described, it is to be understood that the present invention is not limited to the precise construction and components disclosed herein and that various modifications, changes and variations which will be apparent to those skilled in the art may be made in the arrangement, operation and details of the method and apparatus of the present invention disclosed herein without departing from the spirit and scope of the invention as defined in the appended claims.

What is claimed is:

1. A method for applying rules dynamically to data, the method comprising:
receiving a first data from a first source, where the first data is specified in an open programming language, specifying a format to structure a second data and specifying a set of rules corresponding to operations to perform on the second data;
storing the received set of rules and the format into a temporary storage location;
receiving the second data from a second source, the second data including content;
applying the stored format to the second data; and
applying the received set of rules to the content of the second data to produce an output.

2. The method of claim 1, further comprising transmitting the output to an external system.

3. The method of claim 1, wherein the first source and second source are the same.

4. The method of claim 1, wherein the temporary storage location is a volatile memory.

5. The method of claim 1, wherein the second data is received after the first data.

6. The method of claim 1, wherein the second data is received simultaneously with the first data.

7. The method of claim 1, wherein the open programming language is XML.

8. A computer readable medium configured to store instructions executable by a processor, the instructions corresponding to a method for applying rules dynamically to data comprising:
receiving a first data from a first source, where the first data is specified in an open programming language, specifying a format to structure a second data and specifying a set of rules corresponding to operations to perform on the second data;
storing the received set of rules and the format into a temporary storage location;
receiving the second data from a second source, the second data including content;
applying the stored format to the second data; and
applying the received set of rules to the content of the second data to produce an output.

9. The computer readable medium of claim 8, wherein the instructions corresponding to the method further comprises transmitting the output to an external system.

10. The computer readable medium of claim 8, wherein the first source and second source are the same.

11. The computer readable medium of claim 8, wherein the temporary storage location is a volatile memory.

12. The computer readable medium of claim 8, wherein the second data is received simultaneously with the first data.

13. The computer readable medium of claim 8, wherein the open programming language is XML.

14. A system for performing operations on data comprising:
a first data sent from a first source in an open programming language, which specifies a format to structure a second data and specifying a set of rules corresponding to operations to perform on the second data;
a second data sent from a second source, the second data including content;
a rules engine which receives the first data, stores the first data to a temporary storage location, applies the stored format from the first data to the second data, then applies the received set of rules to the content of the second data to produce an output.

15. The system of claim 14 wherein the first source and second source are the same.

16. The system of claim 14 wherein the rules engine transmits the output to an external system.

17. The system of claim 14 wherein the temporary storage location is a volatile memory.

18. The system of claim 14, wherein the open programming language is XML.
